(19) United States
(12) Patent Application Publication
(10) Pub. No.: US 2014/0025270 A1
(43) Pub. Date: Jan. 23, 2014

(54) RADAR INITIATED FOUNDATION BRAKING ONLY FOR AUTONOMOUS EMERGENCY BRAKING SITUATIONS

(71) Applicants: Srikiran KOSANAM, Hyderabad (IN); Thomas J. THOMAS, Brunswick, OH (US)

(72) Inventors: Srikiran KOSANAM, Hyderabad (IN); Thomas J. THOMAS, Brunswick, OH (US)

(73) Assignee: BENDIX COMMERCIAL VEHICLE SYSTEMS LLC

(21) Appl. No.: 13/553,035

(22) Filed: Jul. 19, 2012

(51) Int. Cl. B60T 7/12

(52) U.S. Cl. 701/70

(57) ABSTRACT

When providing adaptive cruise control (ACC) in addition to collision mitigation (CM) for a large vehicle, foundation braking is prohibited for maintaining a set following time behind a forward vehicle in order to mitigate unnecessary brake activations. When collision mitigation is activated, the collision mitigation system is given priority over other vehicle control systems with regard to the foundation brakes, in order to avoid a collision. A lateral acceleration module monitors lateral acceleration of the host vehicle during collision mitigation foundation brake application, and if lateral acceleration exceeds a predetermined threshold, foundation brakes are prohibited in order to prevent vehicle rollover.

### BACKGROUND

The present application finds particular application in hybrid commercial vehicle brake systems, particularly involving collision mitigation systems. However, it will be appreciated that the described technique may also find application in other brake systems, other vehicle control systems, or other brake control systems.

Heavy-duty vehicles, such as large trucks or tractor-trailers, busses, and the like often employ set-speed cruise control (SSCC) systems that govern acceleration when turned on. Additionally, an ACC system may be employed to control vehicle following distance using foundation braking, engine torque reduction, engine retarder, etc., to affect distance to a target forward vehicle. Conventional systems may provide warnings when a preset following distance is breached by a forward vehicle, in order to provide a driver the host vehicle, or tracking vehicle (i.e., the vehicle on which the ACC system is installed) with ample time to respond and avoid collision.

Adaptive cruise control (ACC) systems are used in vehicles for maintaining a safe relative distance between host vehicle and forward vehicle. Torque in the host vehicle is adjusted by an ACC electronic control unit (ECU), based on relative speed, relative acceleration, and/or distance between the host and forward vehicles, to adjust the speed of the host vehicle for maintaining a safe following distance. ACC systems, like all cruise control systems, are active when the driver turns on the appropriate switch(es). Furthermore, like all cruise control systems, ACC systems allow the driver to apply the throttle over and above the amount of throttle being used for the cruise control function.

Collision mitigation (CM) systems operate to avoid or lessen the severity of an impact between host vehicle and a forward vehicle. CM systems operate independently from the state of the ACC and/or cruise control switches. CM systems may calculate that a collision is likely using a combination of relative speed acceleration and/or distance. For example, if the host vehicle approaches a forward vehicle at high relative speed in close distance, a collision may be likely which may activate the CM system.

In conventional systems, foundation braking for commercial vehicles for headway controlling is used when maintaining a set following distance. One problem associated with automatic activation of the foundation brakes is the priority assigned to each potentially conflicting type of brake activation. When the CM system requests foundation braking, braking priority may be given to the stability system, which in turn may cease CM system requested braking.

The present innovation provides new and improved systems and methods that facilitate emphasizing and prioritizing collision mitigation protocols in certain circumstances to permit foundation braking while prohibiting other types of deceleration techniques, which overcome the above-referenced problems and others.

### SUMMARY

In accordance with one aspect, a controller unit that facilitates prioritizing collision mitigation over at least one other type of vehicle control protocol comprises a non-transitory computer-readable medium that stores computer-readable instructions for prioritizing collision mitigation when a collision is determined to be imminent. and a processor that executes the instructions. The instructions comprise monitoring a distance between a host vehicle and a forward vehicle maintaining a set following time behind the forward vehicle by employing at least one of a throttle control component and an engine retarder component while prohibiting foundation braking when the forward vehicle is beyond a predetermined collision mitigation threshold. The instructions further comprise detecting an automatic emergency braking event wherein the forward vehicle breaches the predetermined collision mitigation threshold, and permitting foundation braking upon detection of the automatic braking event.

In accordance with another aspect, a method of prioritizing collision mitigation when a collision is determined to be imminent comprises monitoring a distance between a host vehicle and a forward vehicle, and maintaining a set following time behind the forward vehicle by employing at least one of a throttle control component and an engine retarder component while prohibiting foundation braking when the forward vehicle is beyond a predetermined collision mitigation threshold. The method further comprises detecting an automatic emergency braking event wherein the forward vehicle breaches the predetermined collision mitigation threshold, and permitting foundation braking upon detection of the automatic braking event.

According to another aspect, a system that facilitates emphasizing collision mitigation over other vehicle control systems upon detection of an automatic emergency braking event comprises a forward vehicle sensor that monitors a position of a forward vehicle relative to a host vehicle, a controller comprising a processor configured to monitor a distance between a host vehicle and a forward vehicle, and maintain a set following time behind the forward vehicle by employing at least one of a throttle control component and an engine retarder component while prohibiting foundation braking when the forward vehicle is beyond a predetermined collision mitigation threshold. The processor is further configured to detect an automatic emergency braking event wherein the forward vehicle breaches the predetermined collision mitigation threshold, and permit foundation braking upon detection of the automatic braking event.

In accordance with another aspect, an apparatus for emphasizing collision mitigation over other vehicle control systems upon detection of an automatic emergency braking event comprises means for monitoring a position of a forward vehicle relative to a host vehicle, and means for maintaining a set following time behind the forward vehicle by employing at least one of a throttle control component and an engine retarder component while prohibiting foundation braking when the forward vehicle is beyond a predetermined collision mitigation threshold. The apparatus additionally comprises means for detecting an automatic emergency braking event wherein the forward vehicle breaches the predetermined collision mitigation threshold, and means for permitting foundation braking upon detection of the automatic braking event.

Still further advantages of the subject innovation will be appreciated by those of ordinary skill in the art upon reading and understanding the following detailed description.

### BRIEF DESCRIPTION OF THE DRAWINGS

The innovation may take form in various components and arrangements of components, and in various steps and arrangements of steps. The drawings are only for purposes of illustrating various aspects and are not to be construed as limiting the invention.

FIG. 1 illustrates a system that facilitates prioritizing collision mitigation protocols over other vehicle control protocols (e.g., electronic stability program (ESP), cruise control, etc.) when a forward vehicle breaches a collision mitigation threshold, in accordance with various aspects described herein.

FIG. 2 illustrates a method of controlling vehicle braking while emphasizing collision mitigation to restrict foundation braking when controlling following time of a host vehicle, in accordance with one or more features described herein.

FIG. 3 illustrates a host vehicle that is following a forward vehicle, at a predetermined following time, in accordance with various aspects described herein.

### DETAILED DESCRIPTION

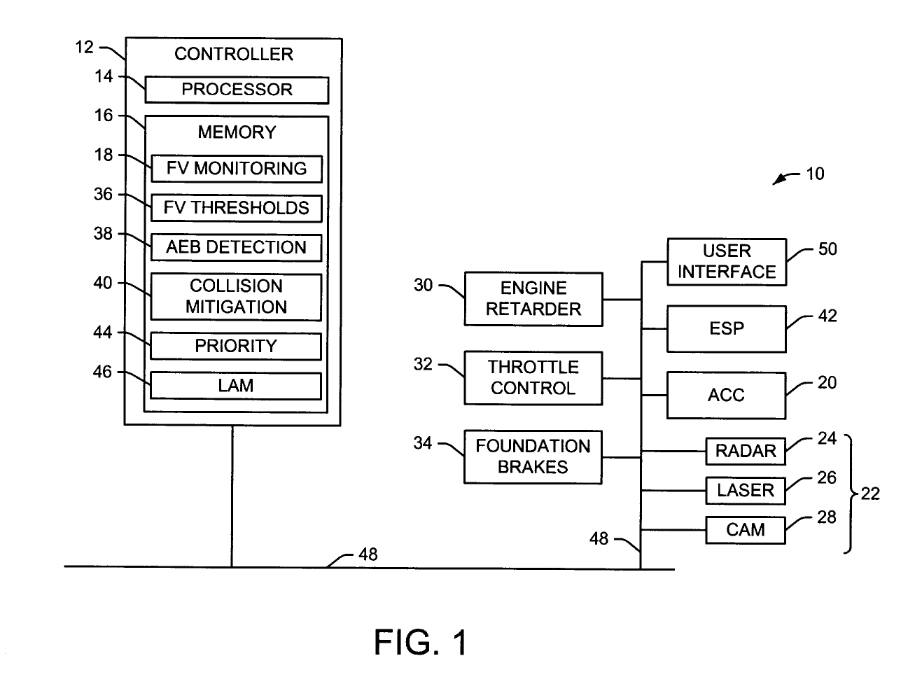

FIG. 1 illustrates a system 10 that facilitates prioritizing collision mitigation protocols over other vehicle control protocols (e.g., electronic stability program (ESP), cruise control, etc.) when a forward vehicle breaches a collision mitigation threshold, in accordance with various aspects described herein. In one embodiment, foundation braking is used only for automatic emergency braking (AEB) situations whereas throttle control and/or engine retarder is used for maintaining a following time. As used herein, “following time” denotes a time window between the host and forward vehicle, which corresponds to a distance that varies as a function of the speeds of the vehicles). For instance, a following time of 3 seconds at 30 miles an hour corresponds to a shorter distance than the same following time at 60 miles per hour.

In another embodiment, a radar sensor is employed with foundation braking only for AEB situations, while foundation braking is not employed for following time control. Conventional systems apply foundation brakes for maintaining a set following time. However, false positive foundation brake interventions that occur during adaptive cruise control detrimentally affect driver safety and fuel economy. By using foundation braking only for AEB situations and using only throttle control and engine retarder for maintaining following time, the described systems and methods facilitate improving driver safety and vehicle fuel economy. Following time refers to the time gap (e.g., in seconds) between the host vehicle and the forward vehicle. The actual physical distance between the host and forward vehicles will vary depending on the speeds of the two vehicles; however, the set time gap is maintained.

To this end, the system 10 includes a controller 12 comprising a processor 14 that executes, and a memory 16 that stores, computer-executable instructions (e.g., modules, routines, programs, applications, etc.) for performing the various methods, techniques protocols, etc., described herein. The memory 16 may include volatile, non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), variants of the foregoing memory types, combinations thereof, and/or any other type(s) of memory suitable for providing the described functionality and/or storing computer-executable instructions for execution by the processor 14. Additionally, “module,” as used herein denotes a set of computer-executable instructions (e.g., a routine, sub-routine, program, application, or the like) that is persistently stored on the computer-readable medium or memory for execution by the processor.

A forward vehicle monitoring module 18 receives forward vehicle status information (e.g., distance to the host vehicle, relative speed, etc.) from an adaptive cruise control (ACC) component 20 and/or from one or more forward vehicle sensors 22 that monitor the distance and velocity of a forward vehicle relative to the host vehicle. For instance, the forward vehicle sensor 22 can comprise one or more of a radar sensor 24, a laser sensor 26, and a camera sensor 28. When a forward vehicle is detected, the ACC component employs one or more of an engine retarder 30 and throttle control component 32 to maintain the host vehicle at a set following time (e.g., 3 seconds or the like) behind the forward vehicle. In order to prevent the ACC component from activating the foundation brakes 34 of the host vehicle during regular ACC control, a foundation braking XBR (external brake request) from the ACC component and/or a forward vehicle sensor (e.g., a radar sensor or the like) is suppressed during ACC operations. In one embodiment, a deceleration request (e.g., the XBR) includes metadata (e.g., a tag or the like) indicating that the foundation brakes are not to be applied.

The memory also stores one or more forward vehicle thresholds 36 (e.g., following time thresholds, collision mitigation thresholds, etc.) For instance, a set following time threshold may be 3 seconds, such that if the forward vehicle is within 3 seconds in front of the forward vehicle, the ACC component employs one or more of the engine retarder 30 and the throttle control component 32 to decelerate the host vehicle until the forward vehicle is at least 3 seconds in front of the host vehicle. An automatic emergency braking (AEB) detection module 38 compares forward vehicle position information to a collision mitigation threshold (e.g., 1 second or the like). If the forward vehicle breaches the collision mitigation threshold, then a collision mitigation module 40 takes over and sends a signal to the foundation brakes 34 to activate the foundation brakes. In one embodiment, when the forward vehicle is within the collision mitigation threshold, the foundation brakes are permitted to be activated but the engine retarder and/or throttle control module are not employed.

In one embodiment, collision mitigation via foundation braking is given priority over other vehicle control systems (e.g., ACC 20, electronic stability program (ESP) 42, and the like) by a priority module 44 as long as the forward vehicle is within the collision mitigation threshold. The priority module 44 may be defined by the SAE J1939 standard. In one embodiment, during collision mitigation events the priority module 44 provides the collision mitigation system a higher priority than the ACC cruise control system and/or the ESP system 42, such that the ACC and ESP systems need not be aware of collision mitigation and/or foundation brake operation. In another embodiment, the collision mitigation is given a highest priority among systems that use the foundation brakes (e.g., ACC, ESP, antilock braking systems, automatic tracking control, etc.).

A lateral acceleration monitoring (LAM) module 46 monitors lateral acceleration of the host vehicle during foundation brake application for collision mitigation and provides an override signal to reinstate prohibition of foundation braking (while permitting one or more other forms of deceleration) if the lateral acceleration of the host vehicle exceeds a predetermined lateral acceleration threshold. In one embodiment, the LAM module 46 receives information from a hardware accelerometer that measures lateral acceleration. In this manner, the LAM module prevents vehicle rollover or other problems associated with lateral acceleration that can occur during aggressive foundation braking.

It will be understood that all components of the system 10 may communicate with each other over a vehicle serial bus 48 (e.g. a J1939 controller area network (CAN) bus or the like). Additionally said components can communicate with a user interface 50 via which warnings and other vehicle status information is presented to the driver.

According to another example, following time is set to, e.g., 3 seconds. Dethrottling is employed to maintain following time down to an approximately 2 second following time. If the forward vehicle breaches the 2 second threshold, a deceleration request is sent to the engine retarder to further decelerate the host vehicle. If the forward vehicle continues to approach the host vehicle and breaches the 1 second threshold, the foundation brakes are requested e.g., solely or in addition to throttle control and engine retarder control. It will be appreciated that the following times and thresholds described herein are presented by way of illustration only, and are not to be construed in a limiting sense.

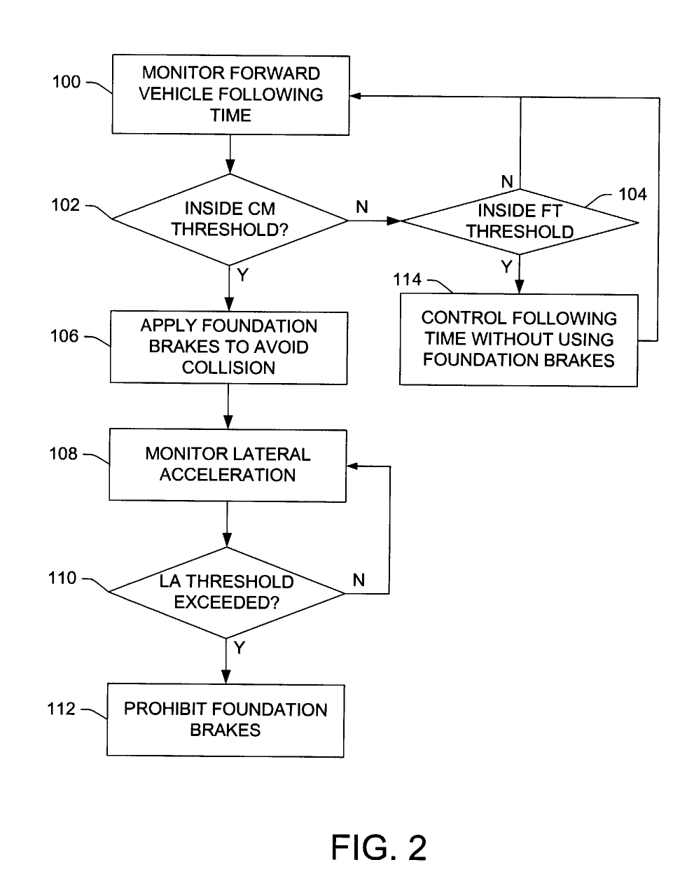

FIG. 2 illustrates a method of controlling vehicle braking while emphasizing collision mitigation to restrict foundation braking when controlling following time of a host vehicle, in accordance with one or more features described herein. At 100, distance to a forward vehicle is monitored. At 102, a determination is made whether the forward vehicle is within a collision mitigation threshold distance. The collision mitigation threshold distance maybe, for example, one second in front of the host vehicle. If the forward vehicle is not within the collision mitigation threshold in front of the host vehicle, then at 104, a determination is made regarding whether the forward vehicle is within a following time threshold. The following time threshold may be, for example, 3 seconds in front of the host vehicle. If the determination and 104 indicates that the forward vehicle is not within 3 seconds in front of the host vehicle than the method reverts to 100 for continued monitoring of the forward vehicle distance.

If the determination at 102 indicates that the forward vehicle is inside the collision mitigation threshold distance, and at 106, foundation brakes are permitted to be applied in order to avoid a collision with the forward vehicle. At 108, lateral acceleration of the host vehicle is monitored during application of the foundation brakes. At 110, a determination is made regarding whether the lateral acceleration of the host vehicle has exceeded a predetermined lateral acceleration threshold, which is set as a function of vehicle speed (e.g., relative speed of the host and forward vehicles or the like). If the determination at 110 indicates that the lateral acceleration of the host vehicle has not exceeded the lateral acceleration threshold, then the method reverts to 108 for continued monitoring of lateral acceleration of the host vehicle. If the determination at 110 indicates that the lateral acceleration of the host vehicle has exceeded the lateral acceleration threshold then at 112 foundation braking is prohibited.

If the determination at 104 indicates that the forward vehicle is inside the following time threshold, and 114 following time is controlled without using foundation brakes (e.g., using only throttle control and the engine retarder). The method then reverts to 100 for continued monitoring of the forward vehicle distance.

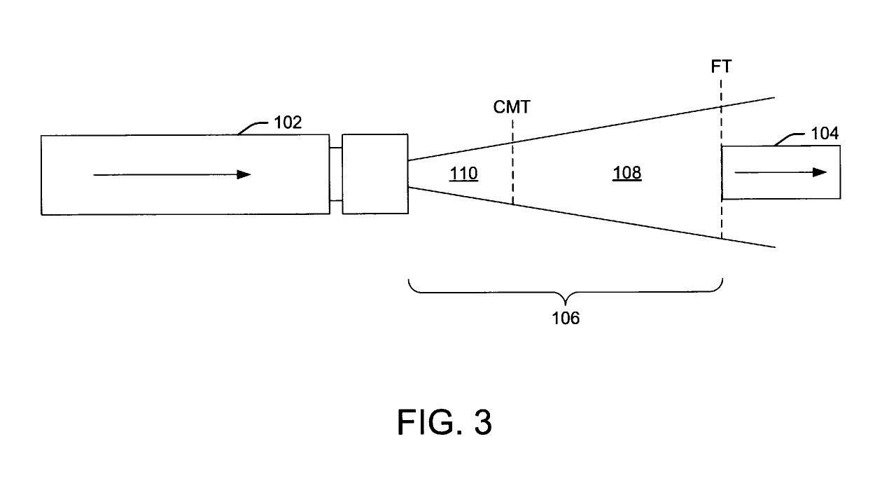

FIG. 3 illustrates a host vehicle 152 that is following a forward vehicle 154, at a predetermined following time 156, in accordance with various aspects described herein. The host vehicle follows the forward vehicle at a prescribed following time which may be a predetermined following time or a following time set by the driver of the host vehicle. The following time threshold, indicated by a dashed line labeled “FT,” when breached by the forward vehicle triggers the ACC component 20 (FIG. 1) to send a signal to at least one of the engine retarder and the throttle control module to decelerate the host vehicle until the forward vehicle is no longer within the following time threshold. That is, if the forward vehicle 154 is within a safe zone 158 within the predetermined following time 156, and the engine retarder in the throttle control module are used to maintain the predetermined following time 156. However, if the forward vehicle breaches a collision mitigation threshold 160 (e.g., within approximately 1 second of the host vehicle, within approximately ⅓ of the predetermined following time 156, or some other threshold), then foundation brakes are permitted to avert a collision. Optionally, the foundation brakes are permitted to the exclusion of the engine retarder and throttle control.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

Having thus described the preferred embodiments, the invention is now claimed to be:

1. A controller unit that facilitates prioritizing collision mitigation over at least one other type of vehicle control protocol, comprising:
a non-transitory computer-readable medium that stores computer-readable instructions for prioritizing collision mitigation when a collision is determined to be imminent; and
a processor that executes the instructions, the instructions comprising:
monitoring a distance between a host vehicle and a forward vehicle;
maintaining a set following time behind the forward vehicle by employing at least one of a throttle control component and an engine retarder component while prohibiting foundation braking when the forward vehicle is beyond a predetermined collision mitigation threshold;
detecting an automatic emergency braking event wherein the forward vehicle breaches the predetermined collision mitigation threshold; and
permitting foundation braking upon detection of the automatic braking event.

2. The controller unit according to claim 1, wherein the instructions for prohibiting foundation braking further comprise:
receiving a deceleration request from a forward vehicle sensor wherein the deceleration request includes a request for at least one of engine retarder deceleration and throttle control deceleration and omits a request for foundation brakes.

3. The controller unit according to claim 1, wherein the instructions for prohibiting foundation braking further comprise:
receiving a deceleration request from a forward vehicle sensor wherein the deceleration request includes metadata indicating that the foundation brakes are not to be applied for maintaining following time.

4. The controller unit according to claim 1, wherein the instructions for permitting foundation braking include permitting foundation braking while prohibiting engine retarder deceleration and throttle control deceleration.

5. The controller unit according to claim 4, the instructions further comprising:
monitoring lateral acceleration of the host vehicle during foundation brake application;
determining that lateral acceleration of the host vehicle has exceeded a predetermined lateral acceleration threshold; and
reinstating prohibition of foundation braking, while permitting at least one other type of deceleration, when the lateral acceleration of the host vehicle has exceeded a predetermined lateral acceleration threshold.

6. The controller unit according to claim 1, wherein the instructions for monitoring the forward vehicle further comprise:
receiving forward vehicle position information from a forward vehicle sensor comprising a radar module coupled to the host vehicle.

7. The controller unit according to claim 1, wherein the instructions for monitoring the forward vehicle further comprise:
receiving forward vehicle position information from a forward vehicle sensor comprising a camera module coupled to the host vehicle.

8. The controller unit according to claim 1, wherein the instructions for monitoring the forward vehicle further comprise:
receiving forward vehicle position information from a forward vehicle sensor comprising a laser module coupled to the host vehicle.

9. The controller unit according to claim 1, wherein the predetermined collision mitigation threshold is approximately 1 second.

10. A method of prioritizing collision mitigation when a collision is determined to be imminent, comprising:
monitoring a distance between a host vehicle and a forward vehicle;
maintaining a set following time behind the forward vehicle by employing at least one of a throttle control component and an engine retarder component while prohibiting foundation braking when the forward vehicle is beyond a predetermined collision mitigation threshold;
detecting an automatic emergency braking event wherein the forward vehicle breaches the predetermined collision mitigation threshold; and
permitting foundation braking upon detection of the automatic braking event.

11. The method according to claim 10, wherein prohibiting foundation braking further comprises:
receiving a deceleration request from a forward vehicle sensor wherein the deceleration request includes a request for at least one of engine retarder deceleration and throttle control deceleration and omits a request for foundation brakes.

12. The method according to claim 10, wherein prohibiting foundation braking further comprises:
receiving a deceleration request from a forward vehicle sensor wherein the deceleration request includes metadata indicating that the foundation brakes are not to be applied for maintaining following time.

13. The method according to claim 10, wherein permitting foundation braking further comprises permitting foundation braking while prohibiting engine retarder deceleration and throttle control deceleration.

14. The method according to claim 13, the instructions further comprising:
monitoring lateral acceleration of the host vehicle during foundation brake application;
determining that lateral acceleration of the host vehicle has exceeded a predetermined lateral acceleration threshold; and
reinstating prohibition of foundation braking, while permitting at least one other type of deceleration, when the lateral acceleration of the host vehicle has exceeded a predetermined lateral acceleration threshold.

15. The method according to claim 10, wherein monitoring the forward vehicle further comprises:
receiving forward vehicle position information from a forward vehicle sensor coupled to the host vehicle and comprising at least one of a radar sensor, a camera sensor, and a laser sensor.

16. The method according to claim 10, wherein the predetermined collision mitigation threshold is approximately 1 second.

17. A system that facilitates emphasizing collision mitigation over other vehicle control systems upon detection of an automatic emergency braking event, comprising:
a forward vehicle sensor that monitors a position of a forward vehicle relative to a host vehicle; and
a controller comprising a processor configured to:
monitor a distance between a host vehicle and a forward vehicle;
maintain a set following time behind the forward vehicle by employing at least one of a throttle control component and an engine retarder component while prohibiting foundation braking when the forward vehicle is beyond a predetermined collision mitigation threshold;
detect an automatic emergency braking event wherein the forward vehicle breaches the predetermined collision mitigation threshold; and
permit foundation braking upon detection of the automatic braking event.

18. The system according to claim 17, wherein the forward vehicle sensor sends a deceleration request that includes a request for at least one of engine retarder deceleration and throttle control deceleration and omits a request for foundation brakes.

19. The system according to claim 17, wherein the forward vehicle sensor sends a deceleration request that includes metadata indicating that the foundation brakes are not to be applied for maintaining following time.

20. The system according to claim 17, wherein the processor is configured to permit foundation braking while prohibiting engine retarder deceleration and throttle control deceleration.

21. The system according to claim 20, wherein the processor is further configured to:
monitor lateral acceleration of the host vehicle during foundation brake application;
determine that lateral acceleration of the host vehicle has exceeded a predetermined lateral acceleration threshold; and
reinstate prohibition of foundation braking, while permitting at least one other type of deceleration, when the lateral acceleration of the host vehicle has exceeded a predetermined lateral acceleration threshold.

22. The system according to claim 17, wherein the forward vehicle sensor is at least one of a radar sensor, a laser sensor, and a camera sensor.

23. The system according to claim 17, wherein the predetermined collision mitigation threshold is approximately 1 second.

24. An apparatus for emphasizing collision mitigation over other vehicle control systems upon detection of an automatic emergency braking event, comprising:
means for monitoring a position of a forward vehicle relative to a host vehicle; and means for maintaining a set following time behind the forward vehicle by employing at least one of a throttle control component and an engine retarder component while prohibiting foundation braking when the forward vehicle is beyond a predetermined collision mitigation threshold;
means for detecting an automatic emergency braking event wherein the forward vehicle breaches the predetermined collision mitigation threshold; and
means for permitting foundation braking upon detection of the automatic braking event.
